(19) United States
(12) Patent Application Publication
(10) Pub. No.: US 2010/0300153 A1
(43) Pub. Date: Dec. 2, 2010

(54) Downward Firing Oxygen-Fuel Burners for Glass Melting Furnaces

(76) Inventors: Zhifa Zhang, Taian (CN); Hao Yang, Taian (CN)

Correspondence Address: DOERNER SAUNDERS DANIEL & ANDERSON, LLP, 320 South Boston, Suite 500, Tulsa, OK, 74103-3725, US

(21) Appl. No.: 12/707,315

(22) Filed: Feb. 17, 2010

(30) Foreign Application Priority Data
May 28, 2009 (CN) 200920031440.8

(51) Int. Cl. C03B 3/00; C03B 5/00

(52) U.S. Cl. 65/135.9; 65/335

(57) ABSTRACT

This invention relates to a glass melting furnace with downward firing oxygen-fuel burners placed in the breast walls of the combustion space and adjacent to the skew block. The downward firing oxygen-fuel burner may be placed at an angle so that the oxygen-fuel flame from the downward firing oxygen-fuel burner impinges on the upper surface of the glass bath. The placement and angle of the downward firing oxygen-fuel burner may maximize the amount of heat transferred to the batch cover or the molten glass, ensure the formation of high quality glass products, and protect the integrity of the downward firing oxygen-fuel burners and the glass melting furnace.

### FIELD OF THE INVENTION

This invention relates to the use of downward firing oxygen-fuel burners to improve the performance of glass melting furnaces. More particularly, the downward firing oxygen-fuel burners may be placed in the breast walls of a glass melting furnace at a location and an angle that maximizes the amount of heat transferred to the batch materials or molten glass. This invention also relates to a process for operating the downward firing oxygen-fuel burners.

### BACKGROUND OF THE INVENTION

In order to produce glass products, raw glass-forming materials, which are also known as batch materials, are melted to form molten glass. This melting occurs in a high-temperature enclosure known as a glass melting furnace. The molten glass is subsequently delivered to the forming operations, where the final glass products are shaped.

A glass melting furnace is a refractory enclosure comprised of a glass bath and a combustion space. The glass bath is comprised of a front wall, rear wall, side walls, and bottom paving and contains the batch materials and molten glass. The combustion space is located directly above the glass bath and is defined by a front wall, rear wall, breast walls, and a roof. In a unit glass melting furnace, the multiple subprocesses of continuous glass melting are accomplished in a single pool of molten glass, with the physical dimensions of the pool kept constant. These subprocesses may include, but are not limited to, distributing and heating the batch materials, melting the batch materials, dissolving silica grains, homogenizing the glass, and refining the glass.

The thermal energy required for glass melting is generally provided by fossil fuels and oxidants, which are introduced into the combustion space by burners. Modern glass melting furnaces increasingly use oxygen-fuel combustion technologies where fossil fuel, such as natural gas, reacts with industrial grade or high purity oxygen to generate the required thermal energy. The benefits of oxygen-fuel combustion technologies include, but are not limited to, higher energy efficiency, improved glass quality, lower emissions, and lower capital costs.

In conventional glass melting furnaces, the oxygen-fuel burners are generally placed in the breast walls of the combustion space at a distance of approximately six to eighteen inches above the upper surface of the glass bath (see FIG. 4). Fossil fuels and oxygen are injected into the combustion space along an axis that is parallel or substantially parallel to the upper surface of the glass bath. As a result, the flames of the oxygen-fuel burners are also parallel or substantially parallel to the upper surface of the glass bath. Due to this design, the amount of heat that conventional oxygen-fuel burners can transfer to the batch materials or molten glass through convection is limited.

Placing the oxygen-fuel burners closer to the upper surface of the glass bath could improve convective heat transfer. However, there are two major concerns with this placement. First, due to their high velocities, the flames and products of combustion leaving the oxygen-fuel burners may cause significant disturbances in the surface of the batch materials or molten glass. These disturbances may range from batch material entrainment to changes in the characteristics of the molten glass, thus creating environmental and quality concerns. Second, when the oxygen-fuel burners are located in pairs on opposite breast walls, the opposing oxygen-fuel flames may impinge on each other and be deflected toward the roof of the glass melting furnace, potentially damaging its refractory and adversely impacting the integrity of the glass melting furnace and its service life.

The teachings in U.S. Pat. No. 6,237,369 (the '369 patent) attempt to address these concerns by describing roof-mounted oxygen-fuel burners for a glass melting furnace. According to the '369 patent, roof-mounted oxygen-fuel burners enhance convective heat transfer by allowing the oxygen-fuel flames to impinge on the upper surface of the glass bath. The '369 patent describes the roof-mounted burner as providing a generally laminar gaseous fuel flow and generally laminar oxygen flow downward to the surface of the batch materials. Thus, combustion of the fuel and oxygen takes place at the surface of the batch materials.

However, the invention described in the '369 patent reduces radiant heat transfer from combustion. As described above, the combustion flame impinges on the surface of the batch materials, with the circular frontal area of the flame radiating to the surface of the batch materials and most of the side surface of the flame radiating to the refractory walls. However, since the temperature of the refractory walls is typically limited to 3,000° F. while the oxygen-fuel flame temperature may be 4,790° F., much of the radiant intensity is lost. Thus, there is a need for a design for a glass melting furnace that maximizes both convective and radiant heat transfer to the upper surface of the glass bath while enduring the formation of high quality glass products and preventing damage to the glass melting furnace.

### SUMMARY OF THE INVENTION

The present invention relates to a furnace for melting a solid mixture in order to provide a molten product. The furnace is comprised of a bath enclosure holding the molten product, a combustion space above the bath enclosure, and a downward firing burner. In particular, the downward firing burner may be placed in the breast wall of the combustion space at a location and an angle that may maximize convective and radiant heat transfer to the bath's surface.

The present invention relates to a downward firing burner comprised of an inner fuel conduit surrounded by a concentric outer oxidant conduit. The burner may be placed at a location and an angle in the breast wall of the furnace such that the transfer of heat to the materials in the bath enclosure is maximized.

The present invention relates to a glass melting furnace comprised of a glass bath, a combustion space above the glass bath, and downward firing oxygen-fuel burners. In particular, the downward firing oxygen-fuel burners are placed in the breast walls of the combustion space at a location and an angle that may maximize convective and radiant heat transfer to the batch materials or molten glass.

The present invention also relates to a method of producing molten glass in a glass melting furnace. The method comprises the steps of providing a glass bath, a combustion space, and a downward firing oxygen-fuel burner with an inner fuel conduit surrounded by a concentric outer oxidant conduit; placing the downward firing oxygen-fuel burner in the breast wall of the combustion space at a location and an angle; injecting a jet of gaseous fuel through the inner fuel conduit; injecting a jet of oxidant through the concentric outer oxidant conduit; and combining the gaseous fuel and the oxidant to produce an oxygen-fuel flame that impinges on the upper surface of the glass bath.

These and other features, aspects, and advantages of the present invention will become better understood with reference to the following drawings, description, and claims.

### BRIEF DESCRIPTION OF THE DRAWINGS

FIG. 1 is a cross-sectional longitudinal view of a glass melting furnace in accordance with an embodiment of the present invention.

FIG. 2 is a cross-sectional view of a downward firing burner in accordance with an embodiment of the present invention.

FIG. 3 is a cross-sectional view of a glass melting furnace in accordance with an embodiment of the present invention.

FIG. 4 is a cross-sectional view of a glass melting furnace in accordance with the prior art.

FIG. 5 is a cross-sectional plan view of a glass melting furnace in accordance with an embodiment of the present invention.

FIG. 6 is a cross-sectional plan view of a glass melting furnace in accordance with an embodiment of the present invention.

FIG. 7 is a cross-sectional plan view of a glass melting furnace in accordance with an embodiment of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

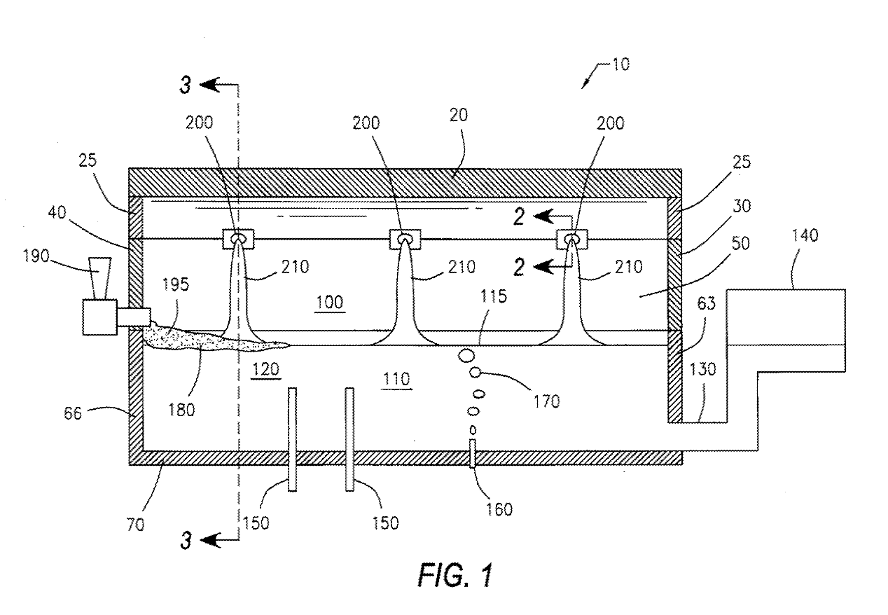

Broadly, the current invention includes systems, devices, and methods for enhancing the performance of glass melting furnaces. More particularly, the invention relates to the placement of downward firing oxygen-fuel burners at an angle in the breast walls of the glass melting furnace so that the oxygen-fuel flames impinge on the upper surface of the glass bath. The invention thus maximizes the amount of heat transferred to the batch materials or molten glass while ensuring the formation of high quality glass products and preventing damage to the glass melting furnace and its components. It will be appreciated that the detailed construction of the devices illustrated in FIGS. 1-7 is intentionally omitted for purposes of clarity.

Referring to FIG. 1, a glass melting furnace 10 may comprise a refractory enclosure having two sections: a glass bath 110 and a combustion space 100 located directly above the glass bath 110. The glass bath 110, which contains molten glass 120, is comprised of a front wall 63, rear wall 66, side walls (not shown), and bottom paving 70. The molten glass 120 in the glass bath 110 has an upper surface 115 that defines the base of the combustion space 100. The combustion space 100 may further be comprised of a front wall 30, rear wall 40, breast walls 50, and a roof 20. The roof 20 may be supported by a skew block 25 placed atop each breast wall 50.

One or more batch chargers 190 may be used to introduce batch materials 195 into the glass melting furnace 10. Typical raw glass batch materials include but are not limited to silica, pyrophyllite, feldspar, limestone, dolomite, borax, potash, gypsum, soda ash, and mixtures thereof. Minor ingredients such as carbon, sulfates, and fluorites may also be incorporated into the batch materials. As an alternative, batch materials may be comprised of recycled glass products such as scrap glass fiber. As another alternative, batch materials may be comprised of a combination of raw glass batch materials and recycled glass products.

Batch chargers 190 may generally be located from six to eighteen inches above the upper surface 115 of the glass bath 110. Batch materials 195 may be fed through the batch charger 190 into the glass melting furnace 10.

Because the batch materials 195 have a lower density than the molten glass 120, the batch materials 195 may generally float on the upper surface 115 of the glass bath 110 in the form of a batch cover 180. The batch cover 180 may be heated by oxygen-fuel flames 210 from downward firing oxygen-fuel burners 200 placed in the breast walls 50 of the glass melting furnace 10. The downward firing oxygen-fuel burners 200 are generally placed in the breast walls 50 but may be placed in the front wall 30 or rear wall 40 without departing from the scope of the invention. The batch cover 180 may also be heated by the molten glass 120 that supports the batch cover 180. In some instances, additional thermal energy may be introduced into the glass melting furnace 10 by passing electric currents from one or more pairs of cross-fired electrodes 150 through the molten glass 120. In order to control the flow patterns of the molten glass 120, bubblers 160 may be inserted through the bottom paving 70 and used to inject gaseous bubbles 170 into the molten glass 120. After the batch cover 180 has melted, the molten glass 120 may exit the glass melting furnace 10 through a glass melting furnace throat 130 and a front-end delivery system 140.

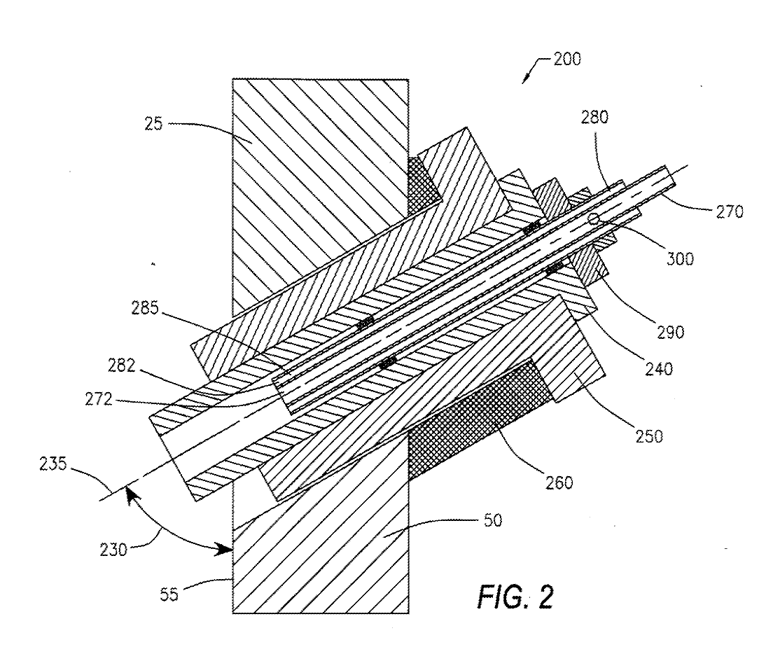

FIG. 2 presents a cross-sectional view of a downward firing oxygen-fuel burner 200. The downward firing oxygen-fuel burner 200 may have a cylindrical inner fuel conduit 270 that supplies gaseous fuel, including but not limited to natural gas, to the downward firing oxygen-fuel burner 200. The fuel conduit 270 may be surrounded by a concentric cylindrical outer oxidant conduit 280, which supplies oxidant to the downward firing oxygen-fuel burner 200 through an annular cavity 285 between the fuel conduit 270 and the oxidant conduit 280. The discharging end 272 of the fuel conduit 270 may be flush or substantially flush with the discharging end 282 of the oxidant conduit 280. The fuel conduit 270 and the oxidant conduit 280 may be constructed of a metal with oxidation-resistant properties, including but not limited to stainless steel and Inconel®. Inconel® is a registered trademark for a family of nickel-chromium-based superalloys that are formed in a proprietary process.

The fuel conduit 270 and the oxidant conduit 280 may be mounted on an inner burner block 240 with a mounting frame 290. An adjustment collar 300 may be used to properly adjust the insertion depth of the fuel conduit 270 and the oxidant conduit 280 into the inner burner block 240. The inner burner block 240 may be inserted into an outer burner block 250 for easy replacement during operation. The inner burner block 240 and the outer burner block 250 may be comprised of refractory materials that are selected to withstand the oxygen-fuel flame 210 and the high-temperature environment inside the glass melting furnace 10. The outer burner block 250 may be placed in an opening in the breast wall 50 of the glass melting furnace 10. A support refractory block 260 may be provided in order to maintain the structural integrity and placement of the downward firing oxygen-fuel burner.

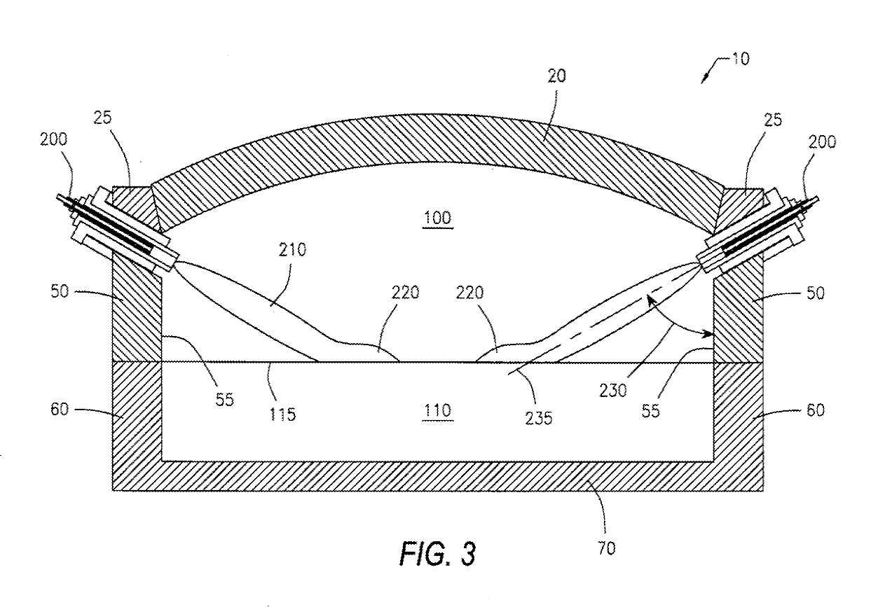

Referring to FIG. 1, the downward firing oxygen-fuel burner 200 may be placed in the breast wall 50 adjacent to the skew block 25. Further, referring to FIGS. 2 and 3, the downward firing oxygen-fuel burner 200 may be placed at an angle 230 so that the oxygen-fuel flame 210 impinges on the upper surface 115 of the glass bath 110. This angle 230 may vary from about 20° to about 80°, as measured between the longitudinal axis 235 of the downward firing oxygen-fuel burner 200 and the inner surface 55 of the breast wall 50 in which the downward firing oxygen-fuel burner 200 has been placed. As described below, this placement may simultaneously maximize the amount of convective and radiant heat transferred to the batch cover 180 or the molten glass 120, ensure the formation of high quality glass products, and prevent damage to the oxygen-fuel burners 200 or the glass melting furnace 10.

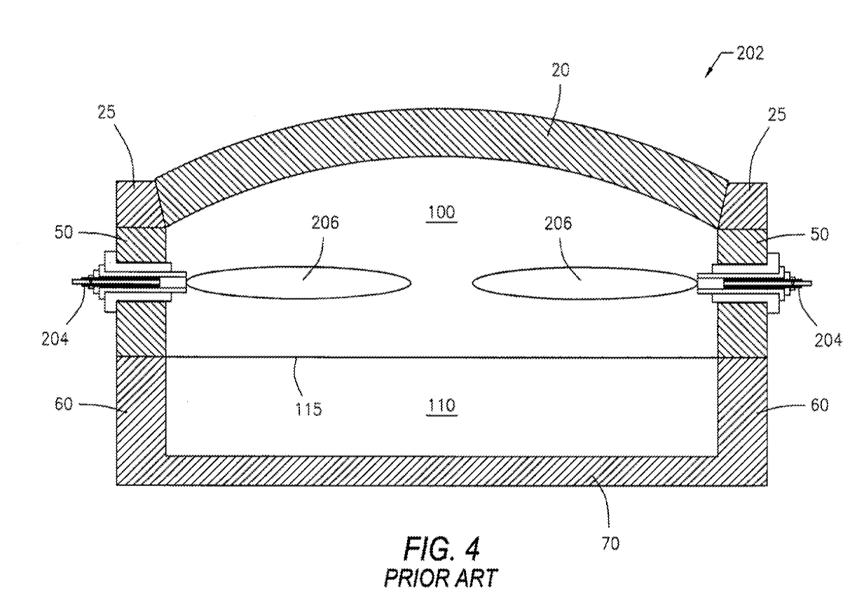

As shown in FIG. 3, the oxygen-fuel flame 210 from the downward firing oxygen-fuel burner 200 may extend along the longitudinal axis 235 of the downward firing oxygen-fuel burner 200. The oxygen-fuel flame 210 may provide radiant heat to the batch cover 180 or molten glass 120 as it travels along the longitudinal axis 235. The radiant heat transfer from the downward firing oxygen-fuel burner 200 may be substantially equivalent to that of conventional glass melting furnaces 202, which have oxygen-fuel burners 204 that produce oxygen-fuel flames 206 which are parallel or substantially parallel to the upper surface 115 of the glass bath 110 (FIG. 4). However, due to the cylindrical or substantially cylindrical shape of the oxygen-fuel flame 210, the oxygen-fuel flame envelope 220 reaching the upper surface 115 of the glass bath 110 may also transfer significant heat energy to the batch cover 180 or the molten glass 120. The amount of radiant thermal energy transferred to the batch cover 180 or the molten glass 120 may be proportional to the temperature (T) of the oxygen-fuel flame 210 to the fourth power (T⁴).

In addition, due to the angle 230 of the downward firing oxygen-fuel burner 200, the oxygen-fuel flame 210 may impinge on the upper surface 115 of the glass bath 110. As a result of this impingement, the oxygen-fuel flame 210 may spread out from its firing path, creating large areas where convective heat transfer is enhanced and increasing the overall rate of thermal energy transfer. Using downward firing oxygen-fuel burners 200 may also produce a more uniform temperature distribution inside the glass melting furnace 10.

The downward firing oxygen-fuel burner 200 may have a firing capacity ranging from 0.5 to 12 MMBtu/hr. The oxidant for the downward firing oxygen-fuel burner 200 may range from industrial-grade oxygen with an oxygen content of approximately 95% to high purity oxygen with an oxygen content of approximately 99.99%. The term “oxidant” may also include other types of oxidants, including but not limited to air and preheated air. The mass flow rate of the oxidant may vary from 80% to 125% of the fuel-oxidant stoichiometry based on the composition of the fuel and the oxygen content of the oxidant. The fuel velocity at the discharging end 272 of the fuel conduit 270 and the oxidant velocity at the discharging end 282 of the oxidant conduit 280 may be equal or substantially equal, which minimizes the shear stress between the two jets. It is generally known that jets with large velocity differentials produce high levels of shear stresses that lead to shear layer instability or Helmholtz instability. Shear layer instability produces coherent turbulence structures that promote mixing of the two jets.

In the present invention, it may be advantageous to postpone the mixing of the fuel jet and the oxidant jet so that mixing and combustion take place away from the downward firing oxygen-fuel burner 200 and close to the upper surface 115 of the glass bath 110. An advantage of this delay may be to protect the integrity of the downward firing oxygen-fuel burner 200 from the oxygen-fuel flame 210, which may have a temperature as high as 4,790° F. Another advantage may be to maximize the distance between the high temperature zone of the oxygen-fuel flame 210 and the refractory of the breast walls 50 and the roof 20 of the glass melting furnace 10. Another advantage may be to have combustion occur near the upper surface 115 of the glass bath 110 in order to maximize the amount of radiant and convective heat transferred to the batch materials 195 or the molten glass 120.

The velocities at the discharge end 272 of the fuel conduit 270 and the discharge end 282 of the oxidant conduit 280 may be controlled by conventional devices, including but not limited to valves, servo circuits, and other standard controllers used in chemical processes. The impingement velocity of the oxygen-fuel flame 210 may be precisely controlled to enhance convective heat transfer while minimizing the displacement of batch materials 195 onto the breast walls 50 and the roof 20 of the glass melting furnace 10 and the entrainment of batch materials 195 into the exhaust of the glass melting furnace 10.

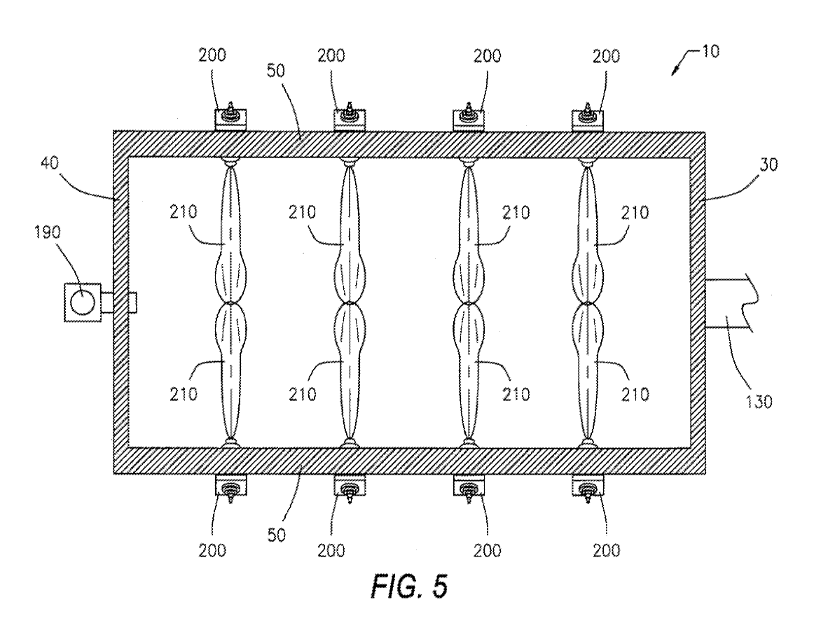

Referring to FIG. 5, an embodiment may be comprised of downward firing oxygen-fuel burners 200 that are placed directly across from each other on opposing breast walls 50 of the glass melting furnace 10. The opposing oxygen-fuel flames 210 may impinge on the upper surface 115 of the glass bath 110, thus maximizing the area covered by the oxygen-fuel flames 210 and the resultant convective heat transfer. This embodiment may also prevent the oxygen-fuel flame 210 from extending too far and impinging on the opposite breast wall 50 of the glass melting furnace 10, which could compromise the integrity of the breast wall 50. This embodiment may also allow the glass melting furnace 10 to operate in a symmetric or substantially symmetric mode that is consistent with an existing design while achieving the benefits of the present invention.

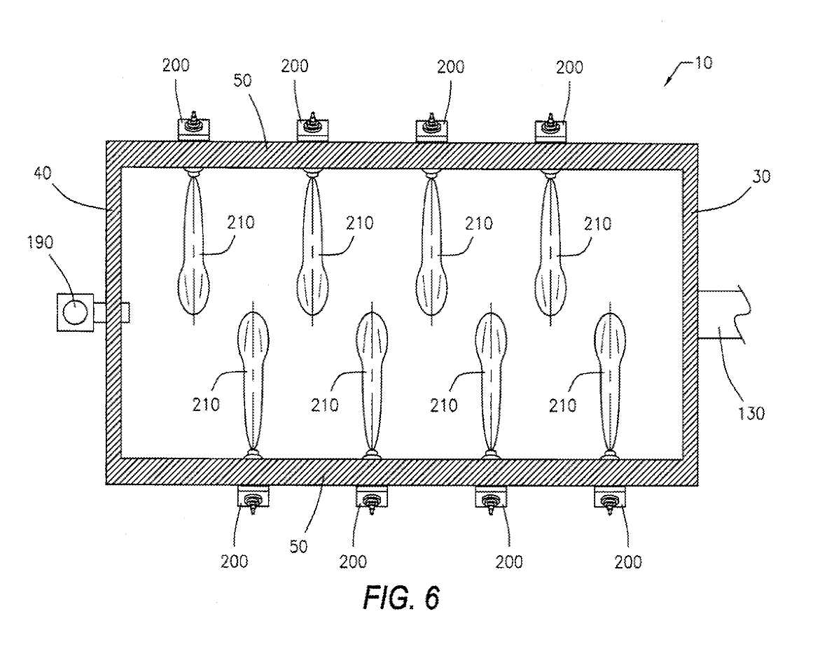

Referring to FIG. 6, an embodiment may be comprised of downward firing oxygen-fuel burners 200 that are placed in a staggered arrangement on opposite breast walls 50 of the glass melting furnace 10. This embodiment may be useful in smaller glass melting furnaces, which may have smaller widths than larger glass melting furnaces. In smaller furnaces with opposing burners, the oxygen-fuel flames 210 could potentially retain enough momentum that the oxygen-fuel flames 210 could collide and bend upward to impinge on the roof 20 or the breast walls 50 of the glass melting furnace 10. An embodiment with staggered burners may provide extended space for the oxygen-fuel flame 210 from each downward firing oxygen-fuel burner 200, eliminating the potential for oxygen-fuel flames 210 to impinge on the roof 20 or the breast walls 50 of the glass melting furnace 10.

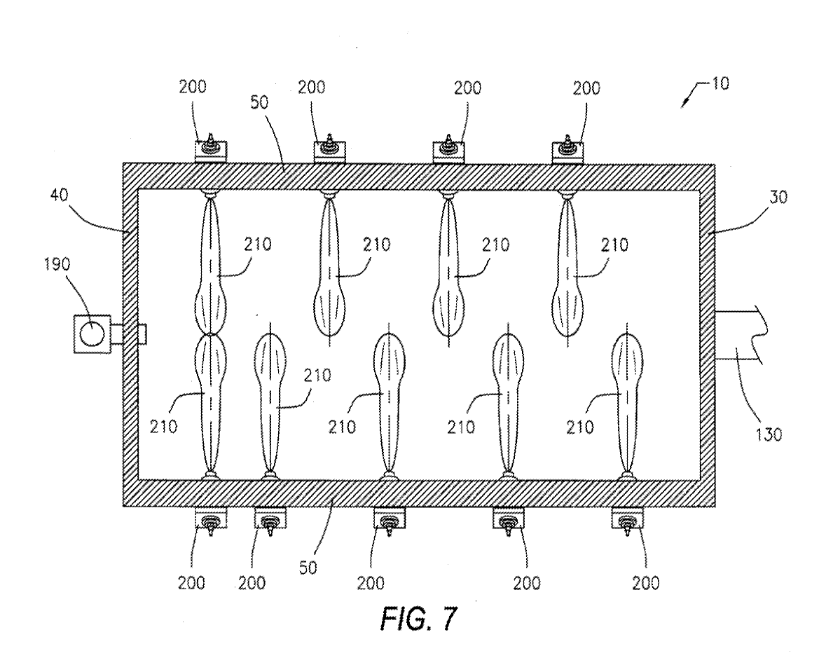

Referring to FIG. 7, an embodiment may be comprised of at least one set of downward firing oxygen-fuel burners 200 that are placed directly across from each other on opposite breast walls 50 and at least one set of downward firing oxygen-fuel burners 200 that are placed in a staggered arrangement on opposite breast walls 50. The opposing set of downward firing oxygen-fuel burners 200 may be placed near the batch charger 190. The embodiment may offer a symmetric or substantially symmetric firing mode to a glass melting furnace 10 with a symmetric batch charging design while protecting the side walls 60, breast walls 50, and roof 20 of the glass melting furnace 10. Thus, the embodiment may offer the operational flexibility to allow glass melting furnaces of a particular design or glass melting furnaces producing particular glass compositions to take advantage of the present invention.

The downward firing oxygen-fuel burner 200 may be installed in different types of furnaces, including but not limited to greenfield glass melting furnaces, rebuild glass melting furnaces, or retrofit production glass melting furnaces. Installing downward firing oxygen-fuel burners 200 in a greenfield or rebuild glass melting furnace may reduce the furnace footprint by enhancing heat transfer and improving glass quality. Reducing the furnace footprint may significantly reduce the capital expenditures associated with that furnace. Downward firing oxygen-fuel burners 200 may also be retrofitted into existing production glass melting furnaces 10 to increase throughput, thus maximizing returns on capital investment.

The downward firing oxygen-fuel burner 200 may use industrial grade oxygen or high purity oxygen as the oxidant in the combustion of gaseous fuels. It is well-known in the art of glassmaking that the absence of nitrogen commonly found in combustion air may reduce the emissions of nitrogen oxides, a greenhouse gas, by greater than 90%, based on a constant glass product production rate. Further, using the downward firing oxygen-fuel burner 200 may increase energy efficiency, thereby reducing emissions of carbon dioxide by greater than 40%, based on a constant glass product production rate.

Further, use of the downward firing oxygen-fuel burner 200 may enhance the chemical homogenization and fining performance of the glass melting furnace 10, thus providing additional benefits to glass melting and product forming operations. Improving chemical homogeneity and reducing gaseous inclusions may result in higher glass quality for the product forming operations. Improved glass quality may also yield higher product conversion efficiencies, particularly when fine fibers with fiber diameters less than nine microns are produced. Further, reducing or eliminating gaseous inclusions may yield glass fiber products with higher electric resistivity for a variety of electric and electronic applications.

The present invention may provide a means to produce glass of advanced and unconventional composition that possesses superior properties compared to conventional glass products. For example, glass compositions for reinforcement glass fibers, which must have higher tensile strength and higher elastic modulus than conventional glass fibers, are more sensitive to temperature gradients and heat transfer characteristics, making them difficult to form in conventional glass melting furnaces 202. By enhancing heat transfer and thermal energy penetration, downward firing oxygen-fuel burners 200 may offer a viable means to produce reinforcement glass fibers with improved mechanical and chemical properties, helping to meet the demand for advanced composite materials.

The present invention may be described in the context of glass melting furnaces. However, the invention may be applicable to other operations that use furnaces or similar structures to convert solid materials into a molten state, either for direct use or in preparation for further processing. Such'furnaces or structures may also be comprised of a bath enclosure, a combustion space, and a plurality of downward firing burners. Potential applications may include, but are not limited to, smelting and making ceramics other than glass.

From the foregoing, it will be understood by persons skilled in the art that a downward firing oxygen-fuel burner for glass melting furnaces and a process for operating the downward firing oxygen-fuel burner have been provided. The invention is relatively simple and easy to manufacture, yet affords a variety of uses. While the description contains many specifics, these should not be construed as limitations on the scope of the invention, but rather as an exemplification of the preferred embodiments thereof. The foregoing is considered as illustrative only of the principles of the invention. Further, because numerous modifications and changes will readily occur to those skilled in the art, it is not desired to limit the invention to the exact construction and operation shown and described, and accordingly all suitable modifications and equivalents may be resorted to, falling within the scope of the invention. Although this invention has been described in its preferred form with a certain degree of particularity, it is understood that the present disclosure of the preferred form has been made only by way of example and numerous changes in the details of construction and combination and arrangement of parts may be resorted to without departing from the spirit and scope of the invention.

What is claimed is:

1. A furnace for melting a solid mixture in order to provide a molten product, the furnace comprising
a bath enclosure holding the molten product;
a combustion space above the bath enclosure, the combustion space having a front wall, a rear wall, breast walls, and a roof supported by a skew block placed atop each breast wall; and
a downward firing burner with a longitudinal axis
wherein the downward firing burner is placed in the breast wall of the combustion space at a location and an angle inclined downwardly from a horizontal plane.

2. The furnace described in claim 1, wherein the location is adjacent to the skew block.

3. The furnace described in claim 1, wherein the angle is an acute angle measured between the longitudinal axis of the downward firing burner and an inner surface of the breast wall in which the downward firing burner is placed.

4. The furnace described in claim 3, wherein the angle is in a range from about 20° to about 80°.

5. The furnace described in claim 1, wherein a plurality of downward firing burners are placed in an opposing pattern on the breast walls of the combustion space.

6. The furnace described in claim 1, wherein a plurality of downward firing burners are placed in a staggered pattern on the breast walls of the combustion space.

7. The furnace described in claim 1, wherein a first set of downward firing burners is placed in an opposing pattern on the breast walls of the combustion space and a second set of downward firing burners is placed in a staggered pattern on the breast walls of the combustion space.

8. A downward firing burner for transferring heat to materials in a bath enclosure, the burner comprising
an inner fuel conduit; and
a concentric outer oxidant conduit surrounding the inner fuel conduit
wherein the burner has a longitudinal axis and is placed at a location and an angle in a breast wall of a furnace such that the heat transferred to the materials in the bath enclosure is maximized.

9. The downward firing burner described in claim 8, wherein the location is adjacent to a skew block placed atop the breast wall.

10. The downward firing burner described in claim 8, wherein the angle is an acute angle measured between the longitudinal axis of the downward firing burner and an inner surface of the breast wall in which the downward firing burner is placed.

11. The downward firing burner described in claim 8, wherein the angle is in a range from about 20° to about 80°.

12. A glass melting furnace for producing a molten glass product, the glass melting furnace comprising
a glass bath holding the molten glass;
a combustion space above the glass bath, the combustion space having a front wall, a rear wall, breast walls, and a roof supported by a skew block placed atop each breast wall; and
a downward firing oxygen-fuel burner with a longitudinal axis
wherein the downward firing oxygen-fuel burner is placed in the breast wall of the combustion space at a location and an angle inclined downwardly from a horizontal plane.

13. The glass melting furnace described in claim 12, wherein the location is adjacent to the skew block.

14. The glass melting furnace described in claim 12, wherein the angle is an acute angle measured between the longitudinal axis of the downward firing oxygen-fuel burner and an inner surface of the breast wall in which the downward firing oxygen-fuel burner is placed.

15. The glass melting furnace described in claim 14, wherein the angle is in a range from about 20° to about 80°.

16. The glass melting furnace described in claim 12, wherein the downward firing oxygen-fuel burner is comprised of an inner fuel conduit surrounded by a concentric outer oxidant conduit, the inner fuel conduit emitting a jet of gaseous fuel with a fuel velocity, the outer oxidant conduit emitting a jet of oxidant with an oxidant velocity.

17. The glass melting furnace described in claim 16, where the fuel velocity and the oxidant velocity are approximately equal.

18. The glass melting furnace described in claim 12, wherein the downward firing oxygen-fuel burners are placed in an opposing pattern on the breast walls of the combustion space.

19. The glass melting furnace described in claim 12, wherein the downward firing oxygen-fuel burners are placed in a staggered pattern on the breast walls of the combustion space.

20. The glass melting furnace described in claim 12, wherein a first set of downward firing oxygen-fuel burners is placed in an opposing pattern on the breast walls of the combustion space and a second set of downward firing oxygen-fuel burners is placed in a staggered pattern on the breast walls of the combustion space.

21. A method of producing molten glass in a glass melting furnace, the method comprising the steps of
providing a glass bath;
providing a combustion space above the glass bath, the combustion space having a front wall, a rear wall, breast walls, and a roof supported by a skew block placed atop each breast wall;
providing a downward firing oxygen-fuel burner with an inner fuel conduit surrounded by a concentric outer oxidant conduit, the downward firing oxygen fuel burner having a longitudinal axis;
placing the downward firing oxygen-fuel burner in the breast wall of the combustion space at a location and an angle;
injecting a jet of gaseous fuel having a fuel velocity through the inner fuel conduit;
injecting a jet of oxidant having an oxidant velocity through the concentric outer oxidant conduit; and
combining the gaseous fuel and the oxidant to produce an oxygen-fuel flame that impinges on the upper surface of the glass bath.

22. The method described in claim 21, wherein the location is adjacent to a skew block.

23. The method described in claim 21, wherein the angle is an acute angle measured between the longitudinal axis of the downward firing oxygen-fuel burner and an inner surface of the breast wall in which the downward firing oxygen-fuel burner is placed.

24. The method described in claim 23, wherein the angle is in a range from about 20° to about 80°.

25. The method described in claim 21, wherein the fuel velocity and the oxidant velocity are approximately equal.
